(19) United States
(12) Patent Application Publication
(10) Pub. No.: US 2003/0083970 A1
(43) Pub. Date: May 1, 2003

(54) Methods and systems for offering financial products

(76) Inventors: Aaron H. Bigman, Richmond, VA (US); Marcelle N. Schwab, Arlington, VA (US)

Correspondence Address: Finnegan, Henderson, Farabow,, Garrett & Dunner, L.L.P., 1300 I Street, N.W., Washington, DC, 20005-3315, US

(21) Appl. No.: 10/283,163

(22) Filed: Oct. 30, 2002

Related U.S. Application Data
(60) Provisional application No. 60/330,859, filed on Nov. 1, 2001.

(51) Int. Cl. G06F 17/60

(52) U.S. Cl. 705/35

(57) ABSTRACT

Methods and systems are provided for offering financial products. The methods and systems may include offering a first financial product to a subject based upon subject data and receiving a first response from the subject regarding the first financial product offer. If the first response comprises a rejection of the offer for the first financial product, then a second financial product may be offered to the subject based upon the subject data. In one embodiment, the subject data may be received from the subject. Also, if the subject accepts the offer for the first or second financial product offer, then the acceptance of the offer may be processed resulting in, for example, the financial product being provided to the subject.

### CROSS REFERENCE TO RELATED APPLICATION

Under the provisions of 35 U.S.C. §119(e), Applicants hereby claim the benefit of priority to U.S. Provisional Application No. 60/330,859, entitled “Methods and Systems for Providing Financial Product Counter Offers to Consumers, filed on Nov. 1, 2001, which is expressly incorporated herein by reference to its entirety.

### TECHNICAL FIELD

The present invention generally relates to the field of marketing and to methods and systems for presenting offers to consumers. More particularly, embodiments of the invention relate to methods and systems for offering products to consumers, such as financial products.

### BACKGROUND INFORMATION

A wide variety of financial products have been created and made available to consumers. Financial products, such as savings accounts, checking accounts, debit accounts, credit card accounts and loans of various types, have been and continue to be used in the day-to-day lives of most people. For example, with the advent and steady growth of electronic commerce, financial products are increasingly being utilized to pay or receive payment for products and services sold through the Internet. Growth in the financial sector has also permitted consumers to use a wide variety of financial products to conduct transactions or make investments according to their needs. For instance, when purchasing a new car or home, a consumer will typically have a number of available options for structuring the necessary financing or acquiring a loan for the purchase.

Traditionally, the marketing and solicitation of financial products has been conducted through various channels, such as sales agents, direct marketing, telemarketing or general advertisements. More recently, solicitations for financial products have been offered using electronic means, such as through the Internet. In this context, competition between financial institutions and other organizations that offer and provide financial products is ever increasing. Thus, many financial institutions seek to create or develop better ways for attracting and retaining customers.

In an effort to lower operating costs and increase value for its customers and shareholders, many financial institutions wish to solicit or offer financial products in the most effective and efficient manner possible so as to attract and retain customers. Financial account providers may attract new customers, or may retain current customers, by soliciting financial products in new and different ways. To this end, some financial institutions may generate solicitations for financial products directed toward a customer's particular credit history and/or personal interests.

By way of example, a financial institution may offer a credit card account including particular terms. A basic type of credit card solicitation may include, for example, an APR of 19.8%, an annual fee of $20, and a credit limit of $500. Great inefficiencies are created in this procedure because, for example, the subject receiving the solicitation may reject the solicited offer, yet subsequently accept a similar solicited offer from the financial institution's competitor. Accordingly, an effective and efficient manner for offering financial products remains an elusive goal.

In view of the foregoing, there is a need for improved methods and systems for offering financial products to consumers. Moreover, there is a need for a more effective and efficient approach for presenting offers for financial products. Additionally, there is a need for improved methods and systems for managing financial product solicitations to consumers.

### SUMMARY OF THE INVENTION

Consistent with embodiments of the present invention, improved methods and systems are provided for offering financial products to consumers. Specific embodiments of the invention, when implemented, can avoid one or more of the problems typically associated with prior approaches for soliciting financial products, such as those discussed herein above.

In one aspect, a method is provided for offering a financial product. The method may include offering a first financial product to a subject based upon subject data, receiving a first response from the subject regarding the first financial product offer, and offering a second financial product to the subject based upon the subject data if the first response comprises a rejection of the offer for the first financial product.

In another aspect, a system is provided for offering a financial product. The system may include a component for offering a first financial product to a subject based upon subject data, a component for receiving a first response from the subject regarding the first financial product offer, and a component for offering a second financial product to the subject based upon the subject data if the first response comprises a rejection of the offer for the first financial product.

In yet another aspect, a computer-readable medium is provided which stores a set of instructions for offering a financial product, which when executed perform stages comprising: offering a first financial product to a subject based upon subject data; receiving a first response from the subject regarding the first financial product offer; and offering a second financial product to the subject based upon the subject data if the first response comprises a rejection of the offer for the first financial product.

It is to be understood that both the foregoing general description and the following detailed description are exemplary and explanatory only and are not restrictive of the embodiments of the invention, as described. Further features and/or variations may be provided in addition to those set forth herein. For example, the present invention may be directed to various combinations and sub-combinations of the disclosed features and/or combinations and sub-combinations of several further features disclosed below in the detailed description.

### BRIEF DESCRIPTION OF THE DRAWINGS

The accompanying drawings provide a further understanding of the invention and, together with the detailed description, explain features and embodiments of the invention. In the drawings:

FIG. 1 is a functional block diagram of an exemplary system for offering a financial product, consistent with an embodiment of the present invention;

FIG. 2 is a flow chart of an exemplary method for offering a financial product, consistent with an embodiment of the present invention; and

FIG. 3 is a flow chart of an exemplary subroutine that may used in connection with the exemplary method of FIG. 2, consistent with another embodiment of the present invention.

### DETAILED DESCRIPTION

Reference will now be made to various embodiments of the present invention, examples of which are shown in the accompanying drawings and others of which will be apparent from the description herein. In the drawings, the same reference numbers represent the same or similar elements in the different drawings whenever possible.

Consistent with embodiments of the present invention, methods and systems are provided for offering a financial product. As used herein, the term “financial product” includes any and all types of financial accounts, instruments, policies and other arrangements that may be offered by a financial institution. By way of example, financial accounts include savings accounts, checking accounts, credit card accounts, debit accounts and stock or brokerage accounts. Moreover, as further illustrations of financial products, financial instruments include certificates of deposit, loans, mortgages, and letters of credit. Financial policies and arrangements that may also be offered as a financial product include all types of insurance policies, traveler's checks, and stock or mutual funds. One of ordinary skill in the art will appreciate that the foregoing are merely illustrations and that other types of financial products may be offered, consistent with embodiments of the invention.

As further disclosed herein, methods and systems consistent with embodiments of the invention provide financial product offers to a subject. As used herein, the term “subject” refers to any and all individuals and entities. By way of example, a subject may include a current or prospective client of a financial institution offering the financial product. Examples of a subject also include any individual or consumer from the general public, as well as any organization, agency, group or other entity. One of ordinary skill in the art will appreciate that the above examples are merely illustrations and that other types of subjects may receive offers, consistent with the embodiments of the invention.

According to one embodiment, a system is provided for offering a financial product. As further described herein, the system may include a component for offering a first financial product to a subject based upon subject data, a component for receiving a first response from the subject regarding the first financial product offer, and a component for offering a second financial product to the subject based upon the subject data if the first response comprises a rejection of the offer for the first financial product. Additionally, the system may include a component for receiving the subject data from the subject and a component for providing the subject with one of the first financial product and the second financial product if the subject respectively accepts one of the offer for the first financial product and the offer for the second financial product.

The above-described components, such as the component for offering a first financial product, the component for receiving a first response from the subject, the component for offering a second financial product, etc. may comprise elements of, be disposed within, or may otherwise be utilized by or embodied within various platforms or devices. By way of example, such platforms or devices may include a mobile phone, a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device that may receive, transmit, and/or process information. The above-noted devices are exemplary and the various components of the system, such as the component for offering a first financial product, the component for receiving a first response from the, the component for offering a second financial product to the subject, etc. may comprise elements of, be disposed within, or may otherwise be utilized by or embodied within many other platforms or devices without departing from the scope and spirit of the invention.

Moreover, embodiments of the invention may be practiced in electrical circuits comprising discrete electronic elements, packaged or integrated electronic chips containing logic gates, circuits utilizing microprocessors, or on a single chip containing electronic elements or microprocessors. Furthermore, embodiments of the invention may be provided using other technologies capable of performing logical operations such as, for example, AND, OR, and NOT, including but not limited to mechanical, optical, fluidic, and quantum technologies. In addition, the invention may be practiced within a general purpose computer, may be implemented in software either as part of a runtime library routine or software generated by an otherwise conventional compiler, or in any other circuits or system environments.

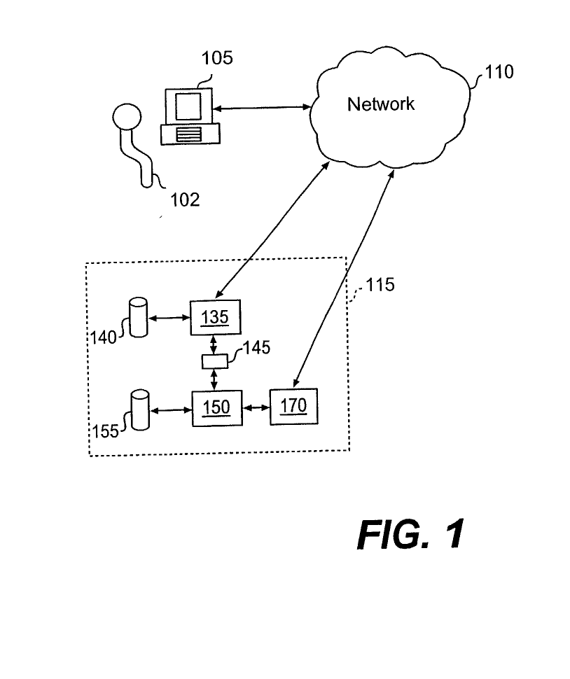

FIG. 1 illustrates an exemplary system environment in which features and embodiments of the invention may be implemented. As shown in FIG. 1, a financial product offering system 100 may comprise a number of elements, including a user computer 105, a network 110, and a financial product management server 115. Embodiments of the invention are not limited to the configuration shown in FIG. 1. As will be appreciated by those skilled in the art, the depicted elements may be combined, modified, substituted or re-arranged, and additional elements may be incorporated or added as needed. For instance, although a single user computer 105 is shown in FIG. 1, additional user computers or devices may be added and/or connected through network 110. Further, by way of an additional example, more than one financial product management server 115 may be provided, according to the needs of the system.

In the exemplary embodiment of FIG. 1, components for offering financial products may be implemented, consistent with the principles of the invention. For example, the component for offering a first financial product, the component for receiving a first response from the subject, the component for offering a second financial product to the subject, the component for receiving the subject data, and/or the component for providing the subject with one of the first financial product and the second financial product may be embodied in server 115. It will be appreciated, however, that other elements of system 100 may comprise the component for offering a first financial product, the component for receiving a first response from the subject, the component for offering a second financial product to the subject, the component for receiving the subject data, and/or the component for providing the subject with one of the first financial product and the second financial product.

User computer 105 may comprise a personal computer, a laptop or other similar microcomputer-based workstation. It will be appreciated, however, that user computer 105 may comprise any type of computer operating environment such as hand-held devices, multiprocessor systems, microprocessor-based or programmable consumer electronics, minicomputers, mainframe computers, and the like. User computer 105 may also be practiced in distributed computing environments where tasks are performed by remote processing devices. Furthermore, user computer 105 may comprise a mobile terminal such as a smart phone, personal digital assistant (PDA), intelligent pager, portable computer, or a hand held computer. A PDA is a handheld computer that serves as an organizer for personal information. It generally includes at least a name and address database, to-do list and note taker. PDAs are typically pen-based and use a stylus (“pen”) to tap selections on menus and to enter printed characters. The unit may also include a small on-screen keyboard which is tapped with the pen. Data may be synchronized between the PDA and a desktop computer through a cable or wireless transmissions.

User computer 105 may be located in a home, office, store, a retail center kiosk, a remote location, or any location wherein it may be operated or accessed. Moreover, as illustrated in FIG. 1, user computer 105 may be operated by a subject 102. Subject 102 may comprise any individual or entity, such as a person or entity seeking a financial product. The person or entity may correspond to a current or prospective client of a financial institution that offers financial product(s). Subject 102 may also be a technician or other user. In addition, user computer 105 may be operated on behalf of subject 102, such as by an employee or agent of an enterprise, organization, or government agency. Subject 102 may also be an agent or employee of a financial institution, a bank, a credit card provider, a financial lending institution, a credit union, a stock brokerage, an insurance company, a government, a utility company, or any other person capable of operating user computer 105. It will appreciate that user computer 105 may be located at a variety of places and operated by a variety of individuals or representatives of entities.

Network 110 facilitates the communication of information between user computer 105 and server 115. Network 110 may comprise one or more communication networks, such as a local area network (LAN), a wide area network (WAN), a wireless network, an intranet and/or the Internet. Such networking environments are commonplace in offices, enterprise-wide computer networks and the like, and are known by those skilled in the art. When network 110 comprises a LAN, user computer 105 and elements of server 115 may be connected to network 110 through a network interface located at each of the respective user computer 105 and elements of server 115. When network 110 comprises a WAN communication environment, user computer 105 and elements of server 115 may include an internal or external modem (not shown) or other means for arranging communications over the WAN, such as the Internet.

In addition to utilizing a wire line communications system to implement network 110, a wireless communications system or a combination of wire line and wireless systems may be utilized as network 110. In either case, network 110 may facilitate, for example, the exchange and transmission of information, e-mail and/or Web pages via the Internet. Network 110 may also be utilized for other communications media.

Wireless communications may be implemented through radio transmission via the airwaves. However, those skilled in the art will appreciate that various other communication techniques can be used to provide wireless transmission including infrared line of sight, cellular, microwave, satellite, packet radio and spread spectrum radio. User computer 105 and elements of server 115 in the wireless environment can be any mobile terminal such as a smart phone, personal digital assistant (PDA), intelligent pager, portable computer, hand held computer, or any device capable of receiving wireless data. Wireless data may include, but is not limited to, paging, text messaging, e-mail, Internet access and/or other specialized data applications specifically excluding voice transmission.

In utilizing network 110, data sent over network 110 may be encrypted to insure data security. When encrypting, the data may be converted into a secret code for transmission over a public network. The original file, or “plaintext,” may be converted into a coded equivalent called “ciphertext” via an encryption algorithm executed, for example, on user computer 105 or on elements of server 115. The ciphertext is decoded (decrypted) at a receiving end and turned back into plaintext.

The encryption algorithm may use a key, which is a binary number that is typically from 40 to 128 bits in length. The greater the number of bits in the key (cipher strength), the more possible key combinations and the longer it would take to break the code. The data is encrypted, or “locked,” by combining the bits in the key mathematically with the data bits. At the receiving end, the key is used to “unlock” the code and restore the original data.

There are a number of cryptographic methods that may be suitable for use with system 100. For example, one method may use a secret key, such as the Data Encryption Standard (DES). In DES, both sender and receiver use the same key to encrypt and decrypt. This can provide a fast method, but transmitting the secret key to the recipient in the first place is not always secure. Another method is public-key cryptography, such as the Rivest-Shamir-Adleman (RSA) highly-secure cryptography method by RSA Data Security, Inc., Redwood City, Calif., (www.rsa.com). RSA uses a two-part concept with both a private and a public key. The private key is kept by the owner; the public key is published. Each recipient has a private key that is kept secret and a public key that is published for everyone. The sender looks up the recipient's public key and uses it to encrypt the message. The recipient uses the private key to decrypt the message. Owners never have a need to transmit their private keys to anyone in order to have their messages decrypted, thus the private keys are not in transit and are not vulnerable.

Public key cryptography software marketed under the name Pretty Good Privacy (PGP) from Pretty Good Privacy, Inc., (PGP) of San Mateo, Calif., (www.pqp.com) may be utilized in connection with embodiments of the invention. PGP was developed by Phil Zimmermann, founder of the company, and it is based on the RSA cryptographic method. A version for personal, non-business use is available on various Internet hosts. While PGP may be used to encrypt data transmitted over network 110, it will be appreciated that many other types of encryption algorithms, methods, and schemes may be employed.

In system 100, data may be transmitted by methods and processes other than or in combination with network 110. These methods and processes may include, but are not limited to, transferring data via diskette, CD ROM, facsimile, conventional mail, an interactive voice response system (IVR), and/or by voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

As illustrated in FIG. 1, server 115 may comprise a first server front end 135 with an associated first server front end database 140, a first server back end 150 with an associated first server back end database 155, and a simple mail transfer protocol (SMTP) server 170. First server front end 135 may be separated from first server back end 150 by a first server firewall 145. One function of first server front end 135 is to provide an interface via network 110 between user computer 105 and server 115. The function of the SMTP server 170 is to provide, for example, an e-mail interface via network 110 between user computer 105 and server 115.

Simple Mail Transfer Protocol or SMTP is a standard e-mail protocol for the Internet. It is a TCP/IP protocol that defines the message format and the message transfer agent (MTA), which stores and forwards the mail. SMTP was originally designed for only ASCII text, but MIME and other encoding methods enable program and multimedia files to be attached to e-mail messages. SMTP servers route SMTP messages throughout the Internet to a mail server, such as a Post Office Protocol 3 (POP3) or an Internet Messaging Access Protocol (IMAP) server, which provides a message store for incoming mail.

Post Office Protocol 3 (POP3) servers, using the SMTP messaging protocol, are standard mail servers commonly used on the Internet. POP3 servers provide a message store that holds incoming e-mail until users log on and download them. With POP3, all pending messages and attachments are downloaded at the same time. Internet Messaging Access Protocol (IMAP) is also a standard mail server that is widely used on the Internet. It provides a message store that holds incoming email until users log on and download them. IMAP, however, is more sophisticated than the POP3 mail server. In IMAP, messages can be archived in folders, mailboxes can be shared, and a user can access multiple mail servers. There is also better integration with MIME, which is used to attach files. For example, users can read only the headers in the message without having to automatically accept and wait for unwanted attached files to download.

First server front end 135 and first server back end 150 may comprise a personal computer or other similar microcomputer-based workstations. It will be appreciated, however, that first server front end 135 and first server back end 150 may comprise any type of computer operating environment such as hand-held devices, multiprocessor systems, microprocessor-based or programmable consumer electronics, minicomputers, mainframe computers, and the like. First server front end 135 and first server back end 150 may also be practiced in distributed computing environments where tasks are performed by remote processing devices. By way of example, first server front end 135 may be implemented on a Compaq Proliant 1600 server running Windows 2000 and Domino Webserver. By way of further illustration, first server back end 150 may be implemented on a Compaq Proliant 1600 server running NT4 and Domino Application Server, and SMTP server 170 may be implemented on a Compaq DL 360 running Windows 2000 and Domino SMTP Mail Server.

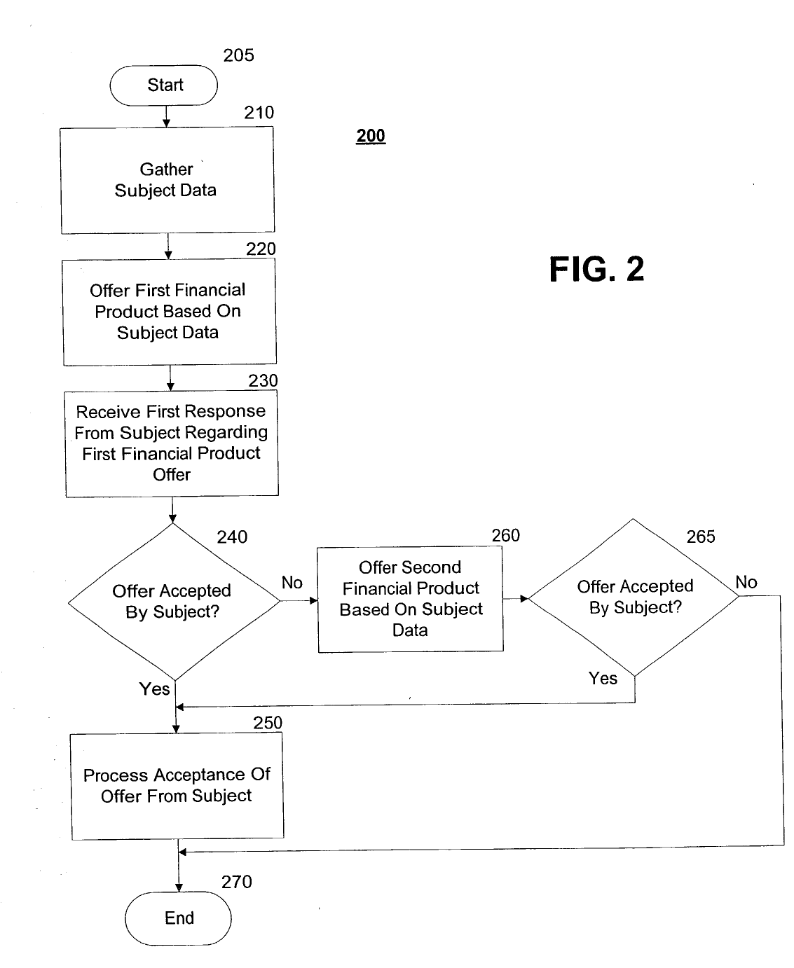

FIG. 2 is a flow chart setting forth the stages of an exemplary method for offering a financial product, consistent with an embodiment of the present invention. As illustrated in FIG. 2, the exemplary method 200 begins at starting block 205 and proceeds to stage 210 where subject data related to subject 102 is gathered. The subject data may be retrieved from a database associated with server 115 and/or the subject data may be received from subject 102. For example, receiving the subject data from subject 102 may comprise using, either alone or in conjunction with system 100, at least one of e-mail, voice mail, facsimile, mail, an item delivery service such as the United States Postal Service, Internet, telephone, diskettes, CD ROM, and/or an interactive voice response system (IVR). The aforementioned elements are exemplary and other elements, methods, or procedures may be employed to receive the subject data from subject 102. Moreover, receiving the subject data from subject 102 may comprise using telemarketing, wherein subject 102 is solicited and the subject data is subsequently received by a person using, for example, a publicly switched telephone network in communication with subject 102. By way of an additional example, subject data may be received from subject 102 by prompting the subject to provide information through one or more pages associated with a Web site.

With respect to subject 102, the subject data may include, for example, age, address, annual income, expenses, employment status, employer, length of employment, past employers, and/or social security number. Moreover, the subject data may include data obtained for a third party source such as a credit reporting bureau. The aforementioned elements comprising the subject data are exemplary and other elements may be employed. In one embodiment, subject data includes data related to subject 102 previously stored or gathered by a financial institution. By way of example, subject 102 may correspond to a customer who closed an account with the financial institution and that is subsequently being offered a first financial product. Alternatively, subject 102 may comprise any other person or enterprise capable of, for example, benefiting from a financial product. Furthermore, the financial institution offering or controlling the financial account may comprise a bank, a credit card provider, a financial lending institution, a credit union, a stock brokerage, an insurance company, a government, or a utility company. The aforementioned financial institution are exemplary and other financial institutions may be employed. Server 115 may be owned or operated by the financial institution, or may be owned by a third party that operates and provides offers through server 115 on behalf of the financial institution.

From stage 210, where subject data is received from subject 102, exemplary method 200 continues to stage 220 where a first financial product is offered to subject 102 based upon the subject data. For example, the first financial product may comprise a credit card account, a financial loan, a checking account, a savings account, or a stock fund. The aforementioned financial products are exemplary and other financial products may be employed. The type of financial product and/or the terms associated with the financial product may be determined by analyzing the subject data. By way of example, the first financial product may comprise a credit card account including a set of specific terms, such as an APR of 19.8%, an annual fee of $20, and a credit limit of $500.

Consistent with embodiments of the invention, various methods and techniques may be employed for determining the first financial product to offer to subject 102 based upon the subject data. For example, the subject data may be analyzed to determine which financial product(s) subject 102 is eligible for based on predetermined eligibility criteria. Additionally or alternatively, the terms associated with the first financial product may be determined based on an analysis of the subject data to determine a credit score or risk of subject 102. Other methodologies may be employed using, for example, general financial and statistical models operating on the subject data or other data such as data obtained from a third party credit reporting bureau relative to subject 102.

After the first financial product is offered to subject 102 based upon the subject data in stage 220, exemplary method 200 advances to stage 230 where a first response is received from subject 102 regarding the first financial product offer. For example, similar to receiving the subject data from subject 102, receiving the first response from subject 102 in stage 230 or offering the first financial product to subject 102 as described above with respect to stage 220 may comprise using, either alone or in conjunction with system 100, at least one of e-mail, voice mail, facsimile, mail, an item delivery service such as the United States Postal Service, Internet, telephone, diskettes, CD ROM, and/or an interactive voice response system (IVR). Moreover, receiving the first response from subject 102 may comprise using telemarketing or pages associated with a Web site.

Once the first response is received from subject 102 regarding the first financial product offer in stage 230, exemplary method 200 proceeds to decision block 240 where it may be determined if the offer was accepted by subject 102. For example, subject 102 may decide that the terms of the first financial product are suitable, and expresses a desire in the first response to benefit from the first financial product. If it is determined at decision block 240 that the offer was accepted by subject 102, exemplary method 200 continues to stage 250 where the acceptance of the offer from the subject 102 is processed. Such processing may include the processing of an application for the first financial product and/or the issuance of the first financial product to subject 102, consistent with embodiments of the invention.

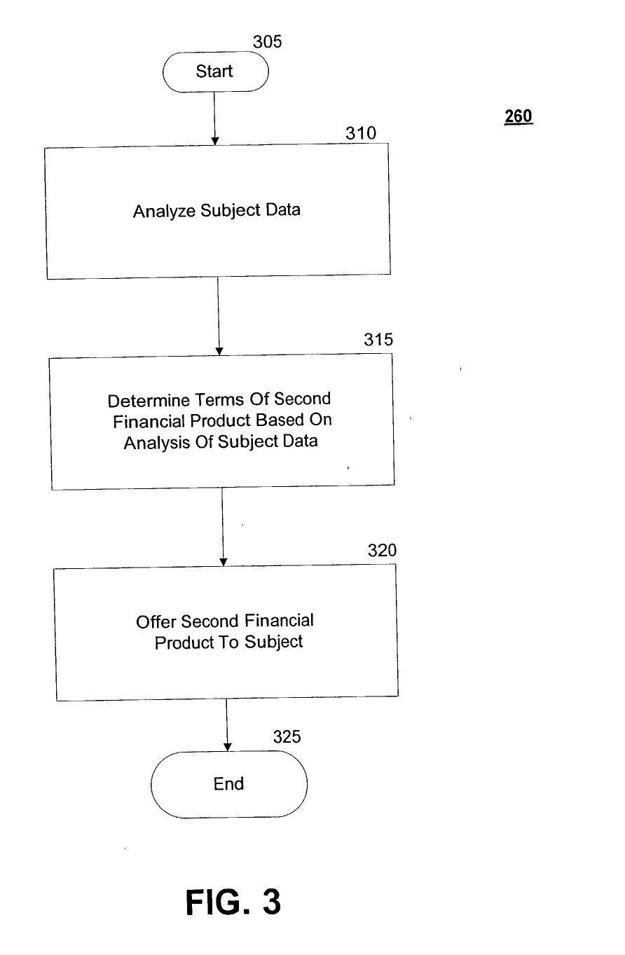

If it is determined, however, at decision block 240 that the offer was not accepted by subject 102, exemplary method 200 advances to stage 260 where a second financial product is offered to subject 102 based upon the subject data. For example, subject 102 may decide that the terms of the first financial product are not suitable, and may express in the first response a desire not to benefit from the first financial product. While subject 102 may desire not to benefit from the first financial product, subject 102 may nonetheless desire to benefit from some form of financial product. The second financial product may be similar or different to the first financial product that was offered to subject 102 and may comprise a credit card account, a financial loan, a checking account, a savings account, or a stock fund. The aforementioned financial products are exemplary and other financial products may be employed. An exemplary method for performing stages 260 is described below with reference to FIG. 3.

After the second financial product is offered to subject 102, a response is received and a decision is made at decision block 265 whether the offer was accepted by subject 102. The receipt of the response from subject 102 in connection with this stage may be implemented in a similar manner to that described for stage 230. Further, similar to the offer for the first financial product, subject 102 may decide that the terms of the second financial product are suitable, and expresses a desire in the second response to benefit from the second financial product. If it is determined at decision block 265 that the offer was accepted by subject 102, exemplary method 200 continues to stage 250 where the acceptance of the offer from the subject 102 is processed. Such processing may include the processing of an application for the second financial product and/or the issuance of the second financial product to subject 102, consistent with embodiments of the invention.

If it is determined, however, at decision block 265 that the second offer was not accepted by subject 102, exemplary method 200 may advance without providing any additional offers to subject 102 and terminate at stage 270. Alternatively, although not shown in FIG. 2, a predetermined number of additional offer(s) may be presented to subject 102 in a manner consistent with the presentation of the second financial product offer. Thus, a financial institution may present a predetermined number of financial product offers (such as three, four or more) and/or may present offers until subject 102 acceptance an offer.

FIG. 3 illustrates a flow chart of an exemplary method for performing exemplary stage or subroutine 260 in FIG. 2. As described above, stage 260 may be performed to offer the second financial product to subject 102, if the first response comprises a rejection of the offer for the first financial product. Referring to FIG. 3, exemplary subroutine 260 begins at starting block 305 and advances to stage 310 where the subject data is analyzed. In addition to the subject data, other data may be analyzed such as data corresponding to why subject 102 rejected the offer for the first financial product. Moreover, if credit data from a credit bureau or credit data clearinghouse was used in determining the offer for the first financial product, this same credit data may be used in analyzing the subject data in stage 310. No new credit bureau or other credit clearinghouse data need be used. Furthermore, the reason why subject 102 rejected the first financial product may be used in the analysis. For example, if subject 102 stated that the first financial product was rejected because of a high APR, the analysis of stage 310 may determine if a lower APR may be offered to subject 102 given the present state of the subject data.

From stage 310 where the subject data is analyzed, exemplary subroutine 260 continues to stage 315 where the second financial product is determined or identified. The second financial product may be of the same type of financial product as the first financial product, but with a different set of terms. In such a case, in stage 315 a second set of terms may be determined corresponding to the second financial product based upon the analysis of the subject data. For example, the second set of terms may be more favorable than a first set of terms corresponding to the first financial product. In the previous example, if subject 102 indicated that the first financial product was rejected because of a high APR and the analysis of stage 310 determined a lower APR may be offered to subject 102, then the second set of terms corresponding to the second financial product may comprise, for example, an APR of 14.8%, an annual fee of $20, and a credit limit of $500, thus reflecting a lower APR. These more favorable terms may increase the probability that subject 102 will accept the second financial product. In another embodiment, the second financial product relates to another type of financial product that is determined to be suitable or attractive to subject 102. In such a case, the identity of and set of terms related to the second financial product may be determined in stage 315 based on the subject data and/or response data from subject 102.Consistent with embodiments of the invention, various methods and techniques may be employed for determining the second financial product to offer to subject 102. As indicated above, the subject data alone or in combination with response data from subject 102 regarding the first financial product may be analyzed to determine the terms of the second financial product. Additionally or alternatively, the terms of the second financial product may be determined based on an analysis of the subject data to determine a credit score or risk of subject 102. Other methodologies may be employed such as using, for example, general financial, randomization, or statistical models operating on the subject data, the response data, other data such as data obtained from a third party credit reporting bureau relative to subject 102, internal or publicly available model scores, interactions with subject 102 at the time of application, data collected (both provided by the applicant and experiential data) during the application process, or data already within a financial institution controlling the financial account (such as, but not limited to, existing account data).

After the terms of the second financial product is determined based upon the analysis of the subject data in stage 315, exemplary subroutine 260 proceeds to stage 320 where the second financial product is offered to subject 102. For example, the second financial product may be offered to subject 102 using, either alone or in conjunction with system 100, at least one of e-mail, voice mail, facsimile, mail, an item delivery service such as the United States Postal Service, Internet, telephone, diskettes, CD ROM, and/or an interactive voice response system (IVR). The aforementioned elements are exemplary and other elements, methods, or procedures may be employed to offer the second financial product to subject 102. Moreover, in one embodiment, the second financial product may be offered to subject 102 on a pre-approved basis. If the second financial product is offered to subject 102 on a pre-approved basis, the probability of subject 102 accepting the second financial product offer may be increased. Furthermore, the time between when the first response from the subject was received and when the second offer is made may be optimized to increase the probability that the second offer will be accepted. For example, studies may show that if the second offer is made two days after the first response was received the acceptance rate of the second offer may be at its highest level. Notwithstanding, the second offer may be made anytime after the first response from the subject is received.

From stage 320 where the second financial product is offered to subject 102, exemplary subroutine 260 continues to stage 325. At stage 325, the subroutine 260 may terminate and generally processing may continue at stage 265 of FIG. 2. Thereafter, the exemplary method may continue as described above.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been described with reference to specific embodiments of the invention. It will be apparent, however, that various variations and modifications may be made to embodiments of the invention, with the attainment of some or all of the advantages of the invention. It is the object of the appended claims to cover these and such other variations and modifications as come within the true spirit and scope of the invention, and their equivalents.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for offering a financial account, comprising:
offering a first financial product to a subject based upon subject data;
receiving a first response from the subject regarding the first financial product offer; and
offering a second financial product to the subject based upon the subject data if the first response comprises a rejection of the offer for the first financial product.

2. The method for offering the financial account of claim 1, further comprising receiving the subject data from the subject.

3. The method for offering the financial account of claim 2, wherein receiving the subject data from the subject comprises using at least one of e-mail, voice mail, facsimile, mail, an item delivery service, Internet, telephone, diskettes, CD ROM, telemarketing, and an interactive voice response system (IVR).

4. The method for offering the financial account of claim 1, further comprising providing the subject with one of the first financial product and the second financial product if the subject respectively accepts one of the offer for the first financial product and the offer for the second financial product.

5. The method for offering the financial account of claim 1, wherein offering the second financial product to the subject based upon the subject data if the first response comprises a rejection of the offer for the first financial product further comprises:
analyzing the subject data;
determining a second set of terms corresponding to the second financial product based upon the analysis of the subject data; and
offering the second financial product to the subject.

6. The method for offering the financial account of claim 5, wherein analyzing the subject data further comprises using response data corresponding to why the subject rejected the offer for the first financial product.

7. The method for offering the financial account of claim 5, wherein determining the second set of terms further comprises using credit data used in formulating the offer for the first financial product.

8. The method for offering the financial account of claim 5, wherein offering the second financial product to the subject further comprises offering the second financial product to the subject on a pre-approved basis.

9. The method for offering the financial account of claim 5, wherein the second set of terms are more favorable than a first set of terms corresponding to the first financial product.

10. The method for offering the financial account of claim 1, wherein at least one of offering the first financial product, receiving the first response from the subject, and offering the second financial product further comprises using at least one of e-mail, voice mail, facsimile, mail, an item delivery service, Internet, telephone, diskettes, CD ROM, telemarketing, and an interactive voice response system (IVR).

11. The method for offering the financial account of claim 1, wherein at least one of the first financial product and the second financial product comprises at least one of a credit card account, a financial loan, a checking account, a savings account, and a stock fund.

12. The method for offering the financial account of claim 1, wherein the subject comprises a customer who closed an account with a financial institution offering the first financial product.

13. The method for offering the financial account of claim 1, wherein a financial institution controlling the financial account comprises at least one of a bank, a credit card provider, a financial lending institution, a credit union, a stock brokerage, an insurance company, a government, and a utility company.

14. The method for offering the financial account of claim 1, wherein a time between receiving the first response and offering the second financial product is optimized to increase a probability that the offer of the second product will be accepted.

15. A system for offering a financial account, comprising:
a component for offering a first financial product to a subject based upon subject data;
a component for receiving a first response from the subject regarding the first financial product offer; and
a component for offering a second financial product to the subject based upon the subject data if the first response comprises a rejection of the offer for the first financial product.

16. The system for offering the financial account of claim 15, further comprising a component for receiving the subject data from the subject.

17. The system for offering the financial account of claim 16, wherein the component for receiving the subject data from the subject is further configured for using at least one of e-mail, voice mail, facsimile, mail, an item delivery service, Internet, telephone, diskettes, CD ROM, telemarketing, and an interactive voice response system (IVR).

18. The system for offering the financial account of claim 15, further comprising a component for providing the subject with one of the first financial product and the second financial product if the subject respectively accepts one of the offer for the first financial product and the offer for the second financial product.

19. The system for offering the financial account of claim 15, wherein the component for offering the second financial product to the subject based upon the subject data if the first response comprises a rejection of the offer for the first financial product is further configured for:
analyzing the subject data;
determining a second set of terms corresponding to the second financial product based upon the analysis of the subject data; and
offering the second financial product to the subject.

20. The system for offering the financial account of claim 19, wherein analyzing the subject data further comprises using response data corresponding to why the subject rejected the offer for the first financial product.

21. The system for offering the financial account of claim 19, wherein determining the second set of terms further comprises using credit data used in formulating the offer for the first financial product.

22. The system for offering the financial account of claim 19, wherein offering the second financial product to the subject further comprises offering the second financial product to the subject on a pre-approved basis.

23. The system for offering the financial account of claim 19, wherein the second set of terms are more favorable than a first set of terms corresponding to the first financial product.

24. The system for offering the financial account of claim 15, wherein at least one of the component for offering the first financial product, the component for receiving the first response from the subject, and the component for offering the second financial product is further configured for using at least one of e-mail, voice mail, facsimile, mail, an item delivery service, Internet, telephone, diskettes, CD ROM, telemarketing, and an interactive voice response system (IVR).

25. The system for offering the financial account of claim 15, wherein at least one of the first financial product and the second financial product comprises at least one of a credit card account, a financial loan, a checking account, a savings account, and a stock fund.

26. The system for offering the financial account of claim 15, wherein the subject comprises a customer who closed an account with a financial institution offering the first financial product.

27. The system for offering the financial account of claim 15, wherein a financial institution controlling the financial account comprises at least one of a bank, a credit card provider, a financial lending institution, a credit union, a stock brokerage, an insurance company, a government, and a utility company.

28. A computer-readable medium on which is stored a set of instructions for offering a financial account, which when executed in a computer-based environment perform stages comprising:
offering a first financial product to a subject based upon subject data;
receiving a first response from the subject regarding the first financial product offer; and
offering a second financial product to the subject based upon the subject data if the first response comprises a rejection of the offer for the first financial product.

29. The computer-readable medium for offering the financial account of claim 28, further comprising receiving the subject data from the subject.

30. The computer-readable medium for offering the financial account of claim 29, wherein receiving the subject data from the subject comprises using at least one of e-mail, voice mail, facsimile, mail, an item delivery service, Internet, telephone, diskettes, CD ROM, telemarketing, and an interactive voice response system (IVR).

31. The computer-readable medium for offering the financial account of claim 28, further comprising providing the subject with one of the first financial product and the second financial product if the subject respectively accepts one of the offer for the first financial product and the offer for the second financial product.

32. The computer-readable medium for offering the financial account of claim 28, wherein offering the second financial product to the subject based upon the subject data if the first response comprises a rejection of the offer for the first financial product further comprises:
analyzing the subject data;
determining a second set of terms corresponding to the second financial product based upon the analysis of the subject data; and
offering the second financial product to the subject.

33. The computer-readable medium for offering the financial account of claim 32, wherein analyzing the subject data further comprises using response data corresponding to why the subject rejected the offer for the first financial product.

34. The computer-readable medium for offering the financial account of claim 32, wherein determining the second set of terms further comprises using credit data used in formulating the offer for the first financial product.

35. The computer-readable medium for offering the financial account of claim 32, wherein offering the second financial product to the subject further comprises offering the second financial product to the subject on a pre-approved basis.

36. The computer-readable medium for offering the financial account of claim 32, wherein the second set of terms are more favorable than a first set of terms corresponding to the first financial product.

37. The computer-readable medium for offering the financial account of claim 28, wherein at least one of offering the first financial product, receiving the first response from the subject, and offering the second financial product further comprises using at least one of e-mail, voice mail, facsimile, mail, an item delivery service, Internet, telephone, diskettes, CD ROM, telemarketing, and an interactive voice response system (IVR).

38. The computer-readable medium for offering the financial account of claim 28, wherein at least one of the first financial product and the second financial product comprises at least one of a credit card account, a financial loan, a checking account, a savings account, and a stock fund.

39. The computer-readable medium for offering the financial account of claim 28, wherein the subject comprises a customer who closed an account with a financial institution offering the first financial product.

40. The computer-readable medium for offering the financial account of claim 28, wherein a financial institution controlling the financial account comprises at least one of a bank, a credit card provider, a financial lending institution, a credit union, a stock brokerage, an insurance company, a government, and a utility company.

41. The computer-readable medium for offering the financial account of claim 28, wherein a time between receiving the first response and offering the second financial product is optimized to increase a probability that the offer of the second product will be accepted.
